(19) United States
(12) Patent Application Publication
(10) Pub. No.: US 2011/0188816 A1
(43) Pub. Date: Aug. 4, 2011

(54) FLEXIBLE OPTOELECTRONIC INTERCONNECTION MODULE AND METHOD OF MANUFACTURING THE SAME

(75) Inventors: Hiroshi Uemura, Yokohama-shi (JP); Hideto Furuyama, Yokohama-shi (JP)

(73) Assignee: KABUSHIKI KAISHA TOSHIBA, Tokyo (JP)

(21) Appl. No.: 13/010,205

(22) Filed: Jan. 20, 2011

(30) Foreign Application Priority Data
Jan. 29, 2010 (JP) 2010-019624

(51) Int. Cl. G02B 6/36; H01R 9/00

(52) U.S. Cl. 385/88; 29/842

(57) ABSTRACT

According to one embodiment, a flexible optoelectronic interconnection module according to one embodiment includes a flexible electrical wiring board including an electrical wire and first electrical connection terminal, and a flexible optoelectronic interconnection board including an optical interconnection path, electrical wire, and second electrical connection terminal and mounted on a partial region of the flexible electrical wiring board. On the flexible optoelectronic interconnection board, an optical semiconductor element electrically connected to the electrical wire of the interconnection board and optically coupled with the optical interconnection path is mounted. The first and second electrical connection terminals are electrically connected by a conductive connecting member.

### CROSS-REFERENCE TO RELATED APPLICATIONS

This application is based upon and claims the benefit of priority from Japanese Patent Application No. 2010-019624, filed Jan. 29, 2010; the entire contents of which are incorporated herein by reference.

### FIELD

Embodiments described herein relate generally to a flexible optoelectronic interconnection module and a method of manufacturing the same.

### BACKGROUND

Recently, demands for high speed and low noise signal transmission between LSI chips in a mobile communication apparatus such as a personal computer or cell phone have been increasing. Accordingly, a high-speed, low-noise optoelectronic interconnection combining an optical interconnection and electrical wire is attracting attention. Examples of the optoelectronic interconnection are an optoelectronic array interconnection module formed by binding an optical fiber and electrical cable, and a flexible printed wiring board including an optical waveguide.

### BRIEF DESCRIPTION OF THE DRAWINGS

FIGS. 1A, 1B, and 1C are plan, bottom, and sectional views showing an arrangement of a flexible optoelectronic interconnection module according to the first embodiment;

FIG. 2 is a sectional view showing a modification of the first embodiment;

FIG. 3 is a plan view showing the modification of the first embodiment;

FIGS. 4A, 4B, and 4C are plan, bottom, and sectional views showing an arrangement of a flexible optoelectronic interconnection module according to the second embodiment;

FIG. 5 is a sectional view showing an arrangement of a flexible optoelectronic interconnection module according to the third embodiment;

FIG. 6 is a sectional view showing a modification of the third embodiment;

FIG. 7 is a sectional view showing an arrangement of a flexible optoelectronic interconnection module according to the fourth embodiment;

FIG. 8 is a sectional view showing an arrangement of a flexible optoelectronic interconnection module according to the fifth embodiment;

FIGS. 9A, 9B, and 9C are plan, bottom, and sectional views showing an arrangement of a flexible optoelectronic interconnection module according to the sixth embodiment;

FIG. 10 is a plan view showing an arrangement of a flexible optoelectronic interconnection module according to the seventh embodiment;

FIG. 11 is a plan view showing a state in which thin-line portions of the flexible optoelectronic interconnection module according to the seventh embodiment are overlaid;

FIGS. 12A, 12B, and 12C are plan views showing modifications of the seventh embodiment; and

FIGS. 13A, 13B, 13C, and 13D are views showing the manufacturing steps of a flexible optoelectronic interconnection module according to the eighth embodiment.

### DETAILED DESCRIPTION

In general, a flexible optoelectronic interconnection module according to one embodiment includes a flexible electrical wiring board including an electrical wire and first electrical connection terminal, and a flexible optoelectronic interconnection board including an optical interconnection path, electrical wire, and second electrical connection terminal and mounted on a partial region of the flexible electrical wiring board. On the flexible optoelectronic interconnection board, an optical semiconductor element electrically connected to the electrical wire of the interconnection board and optically coupled with the optical interconnection path is mounted. The first and second electrical connection terminals are electrically connected by a conductive connecting member.

Embodiments will be explained below with reference to the accompanying drawing. Although the embodiments will be explained by taking several practical materials and arrangements as examples, the embodiments can be practiced by using materials and arrangements having functions similar to those of the embodiments. That is, the present invention is not limited to the following embodiments.

For example, the flexible electrical wiring board includes a flexible printed circuit (FPC) and flexible flat cable (FFC), and the embodiments are applicable to both. Also, a description will be made by taking an FPC using polyimide as a base film as an example, but a liquid crystal polymer or another resin may be used as the base film. Furthermore, the electrical wire of the FPC or FFC can be either a single-layered wire or multilayered wire. In the following embodiments, only the substrate shapes of flexible electrical wiring boards and flexible optoelectronic interconnection boards are shown, and the patterns of optical interconnections and electrical wires are sometimes omitted. The purpose of this is to simplify the explanation, so it is of course possible to form any arbitrary interconnections and wires.

JP 2007-148107 discloses an electrical-wire-integrated optical cable module in which an optical cable module is mounted on an electrical cable. The optical cable module includes a film optical waveguide, optical semiconductor element (light-emitting element or light-receiving element), height compensating member, electrical wire, electrical connecting portion, and substrate. The optical semiconductor element mounted on the substrate is optically coupled with the film optical waveguide mounted on the substrate with the height compensating member being interposed between them. The optical semiconductor element is electrically connected to the electrical wire on the substrate, and connected to the electrical cable by the electrical connecting portion.

In the optical cable module of this type, however, the optical semiconductor element cannot be mounted on the film optical waveguide because the film optical waveguide has no electrical wire. Therefore, the optical semiconductor element must be mounted on a separately prepared substrate. Also, the film optical waveguide must be mounted on the substrate from the optical semiconductor element mounting surface side, so as to be aligned with the optical semiconductor element mounted on the substrate. Accordingly, the height compensating member for making the distance between the optical semiconductor element and film optical waveguide constant must be interposed between the film optical waveguide and substrate. This increases the height of the optical cable module and the height of the electrical-wire-integrated optical cable module including the optical cable module, and makes the downsizing and thinning of an electronic apparatus difficult. In addition, the increase in number of members increases the cost, and often decreases the reliability.

In the flexible optoelectronic interconnection module of the embodiment, a flexible optoelectronic interconnection board including an optical interconnection path and electrical wire is used in a minimum necessary region, and electrically connected to a flexible electrical wiring board (to be simply referred to as a flexible wiring board hereinafter). This makes it possible to secure electrical wires such as a power supply wire and low-speed analog wire, and minimize the member cost by reducing interconnection members required for optical signal transmission to minimum necessary members. Also, the optical interconnection path of the flexible optoelectronic interconnection board and an optical semiconductor element are aligned via the electrical wire of the flexible optoelectronic interconnection board. This significantly decreases the displacement between the optical semiconductor element and optical interconnection path caused by, e.g., temperature fluctuations. Furthermore, since the module does not require any parts except for the flexible optoelectronic interconnection board and flexible wiring board, the number of parts is small, and this further facilitates cost reduction. That is, the flexible optoelectronic interconnection module of the present invention is a low-cost, high-reliability flexible optoelectronic interconnection module.

### First Embodiment

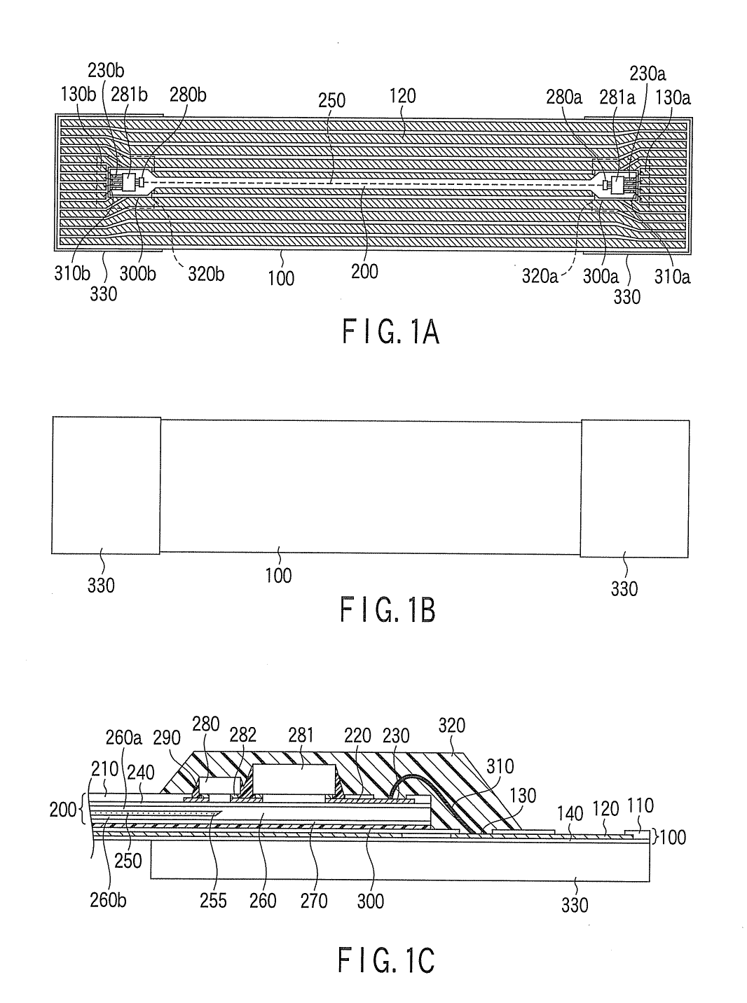

FIG. 1A is a plan view showing the flexible optoelectronic interconnection module from the upper surface side. FIG. 1B is a bottom view showing the module from the lower surface side. FIG. 1C is a sectional view (in a wiring direction) of an optical semiconductor element mounting portion and vicinity of the module. Note that in FIG. 1A, only parts of the flexible optoelectronic interconnection module are shown and denoted by reference numerals.

In FIGS. 1A, 1B, and 1C, reference numeral 100 denotes a flexible wiring board; 110, a cover lay for protecting the upper surface of the flexible wiring board 100; 120, electrical wires of the flexible wiring board 100; 130 (130a and 130b), first electrical connection terminals for electrically connecting the electrical wires 120 to the outside; and 140, a base film as a support member of the flexible wiring board 100.

Reference numeral 200 denotes a flexible optoelectronic interconnection board; 210, a cover lay for protecting the upper surface of the flexible optoelectronic interconnection board 200; 220, electrical wires of the flexible optoelectronic interconnection board 200; 230 (230a and 230b), second electrical connection terminals for electrically connecting the electrical wires 220 to the outside; 240, a base film as a support member of the flexible optoelectronic interconnection board 200; 250, optical waveguide cores as optical interconnection paths of the flexible optoelectronic interconnection board 200; 255, a 45° mirror; 260 (260a and 260b), optical waveguide clads; and 270, a cover lay for protecting the lower surface of the flexible optoelectronic interconnection board 200.

Reference numeral 280 (280a and 280b) denotes an optical semiconductor element such as a light-emitting element and light-receiving element; 281 (281a and 281b), driving ICs for driving the optical semiconductor elements 280; 282, an Au bump; 290, an underfill resin; 300 (300a and 300b), adhesive sheets; 310 (310a and 310b), bonding wires; 320 (320a and 320b), a mold resin; and 330, stiffening plates.

The flexible wiring board 100 and flexible optoelectronic interconnection board 200 are stacked such that an upper surface of the first and second electrical connection terminals 130 and 230 face the same direction (upper direction in FIG. 1C). The first and second electrical connection terminals 130 and 230 are electrically connected by the bonding wires 310.

The flexible wiring board 100 has flexibility, and includes the cover lay 110, electrical wires 120, first electrical connection terminals 130, and base film 140. The base film 140 is, e.g., a polyimide film (the thickness is, e.g., 25 μm), the electrical wire 120 is a Cu foil (e.g., a 12-μm thick rolled Cu foil), and the cover lay 110 is, e.g., a polyimide film (the thickness is, e.g., 25 μm). The flexible wiring board 100 has a laminated structure formed by stacking and laminating these members, and has a width of, e.g., 10 mm and a length of, e.g., 150 mm.

The electrical wires 120 are formed by patterning the Cu foil stacked on the base film 140. The Cu foil of the electrical wires 120 can be a foil integrated with the base film 140 by using an adhesive layer, or a foil directly bonded on the base film 140 by thermocompression after the surface of the foil is roughened. A portion of the electrical wire 120 is plated with, e.g., Ni/Au (the thicknesses are, e.g., 5 μm/0.3 μm), and the plated portion is used as the first electrical connection terminal 130. Note that it is possible to appropriately change the numbers and patterning shapes of the electrical wires 120 and first electrical connection terminals 130 as needed.

The flexible optoelectronic interconnection board 200 has flexibility, and includes the cover lay 210, electrical wires 220, base film 240, first optical waveguide clad 260a, optical waveguide cores 250, second optical waveguide clad 260b, and cover lay 270. The cover lay 210 is, e.g., a polyimide film (the thickness is, e.g., 25 μm), the electrical wire 220 is a Cu foil (e.g., a 12-μm thick rolled Cu foil), the base film 240 is, e.g., a polyimide film (the thickness is, e.g., 25 μm), the first optical waveguide clad 260a is, e.g., an epoxy-based resin (the thickness is, e.g., 10 μm), the optical waveguide core 250 is, e.g., an epoxy-based resin (the thickness is, e.g., 30 μm), the second optical waveguide clad 260b is, e.g., an epoxy-based resin (the thickness is, e.g., 40 μm), and the cover lay 270 is, e.g., a polyimide film (the thickness is, e.g., 25 μm).

The flexible optoelectronic interconnection board 200 has a laminated structure formed by integrating these members by stacking and laminating them. The flexible optoelectronic interconnection board 200 has a length of, e.g., 130 mm, a maximum width (end regions in which the optical semiconductor elements 280 and driving ICs 281 (to be described later) are mounted) of, e.g., 1.5 mm, and a minimum width (an interconnection region connecting the end regions) of, e.g., 1 mm.

The optical semiconductor elements 280 (the width and length are, e.g., 300 μm, and the height is, e.g., 200 μm) and driving ICs 281 (the width and length are, e.g., 1 mm, and the height is, e.g., 300 μm) are mounted on the flexible optoelectronic interconnection board 200. The dimensions of the driving IC 281 are generally larger than those of the optical semiconductor element 280.

The flexible optoelectronic interconnection board 200 includes the optical interconnection layers (the optical waveguide cores 250 and optical waveguide clads 260), and is more expensive than the flexible wiring board 100 having the same size. In this embodiment, therefore, the width of the flexible optoelectronic interconnection board 200 is decreased to a minimum necessary width (in this embodiment, the width of the interconnection region is 1 mm).

Each optical waveguide core 250 of the flexible optoelectronic interconnection board 200 has a width of, e.g., 30 μm, and can perform, e.g., 10-Gbps optical signal transmission. Therefore, when using the flexible optoelectronic interconnection board 200 having an interconnection region width of 1 mm, high-speed signal transmission of 40 Gbps can be performed by forming, e.g., four optical waveguide cores 250.

On the other hand, the electrical wires 120 of the flexible wiring board 100 are used as electrical wires (e.g., low-speed analog wires and power supply wires) that do not require any optical interconnections or cannot be changed into optical interconnections. The electrical wires 120 require a wiring width of, e.g., 300 μm in order to decrease the wiring resistance, and the number of the electrical wires 120 must be equal to the number (e.g., 20) of low-speed analog wires and power supply wires. When inter-wire spaces and design margins are included, therefore, the width (in this embodiment, 10 mm) of the flexible wiring board 100 is larger than that of the flexible optoelectronic interconnection board 200.

When using only one flexible optoelectronic interconnection board 200 for all the wiring needed to perform optical signal transmission, the size of the flexible optoelectronic interconnection board 200 increases, and this increases the cost. By contrast, this embodiment performs electrical wiring and optical signal transmission by mounting the flexible optoelectronic interconnection board 200 in a portion of the flexible wiring board 100 as described above. This makes it possible to decrease the size of the flexible optoelectronic interconnection board 200 to a minimum necessary size, thereby reducing the cost.

The electrical wires 220 are formed by patterning a Cu foil stacked on the base film 240. The Cu foil of the electrical wires 220 can be a foil integrated with the base film 240 by using an adhesive layer, or a foil directly bonded on the base film 240 by thermocompression after the surface of the foil is roughened. A portion of the electrical wire 220 is plated with, e.g., Ni/Au (the thicknesses are, e.g., 5 μm/0.3 μm), and the plated portion is used as the second electrical connection terminal 230. The electrical wires 220 are partially connected to the optical semiconductor elements 280 and driving ICs 281, and can transmit optical signals by electrical input/output (to be described later).

Note that it is possible to appropriately change the numbers and patterning shapes of the electrical wires 220 and second electrical connection terminals 230 as needed. Note also that when the flexible optoelectronic interconnection board 200 has an extra space, an electrical wire different from the electrical wires connected to the optical semiconductor elements 280 and driving ICs 281 may be formed from one end to the other of the flexible optoelectronic interconnection board 200. This additional electrical wire can be used to transmit electrical signals (e.g., low-speed analog signals), or supply electric power as a power supply wire.

The optical waveguide cores 250 and optical waveguide clads 260 (260a and 260b) are made of a material (e.g., an acryl-based resin or epoxy-based resin) transparent to the optical transmission wavelength, and form an optical interconnection layer. To form the optical interconnection layer, the first optical waveguide clad 260a and optical waveguide core 250 are sequentially stacked and laminated on the base film 240, and the optical waveguide core 250 is patterned in accordance with the patterning shape of the electrical wires 220. Subsequently, the second optical waveguide clad 260b is stacked and laminated on the patterned optical waveguide core 250. Since the refractive index of the optical waveguide core 250 is higher than that of the optical waveguide clad 260, light having entered the optical waveguide core 250 as an optical interconnection path is confined in the optical waveguide core 250 and propagates through it.

By forming the optical interconnection layer as described above, the optical waveguide cores 250 and electrical wires 220 can be aligned with a very high accuracy. In the flexible optoelectronic interconnection board 200, therefore, the accuracy of alignment between the optical semiconductor elements 280 and optical waveguide cores 250 can be made higher than that of a composite flexible optoelectronic interconnection board in which a flexible optoelectronic interconnection board and flexible electrical wiring board formed independently of each other are aligned and laminated. In addition, it is possible to decrease the relative positional fluctuations between the optical semiconductor elements 280 and optical waveguide cores 250 caused by temperature changes. Accordingly, a flexible optoelectronic interconnection module having a high productivity and high reliability can be implemented.

Note that the above-mentioned optical waveguide cores 250 can also be formed by using a resin that changes its refractive index when exposed to light as an optical waveguide film, and performing pattern exposure on this optical waveguide film. Note also that the above-mentioned optical interconnection layer formation method is an example in which the electrical wires 220 are formed first, and then the optical waveguide cores 250 are patterned in alignment with the patterning shape of the electrical wires 220. However, it is also possible to form an optical interconnection layer first, and then pattern the electrical wires 220 in alignment with the patterning shape of the optical waveguide cores 250. The number and patterning shape of the optical waveguide cores 250 can appropriately be changed as needed.

The 45° mirrors 255 are formed at the two ends of the optical waveguide core 250. Since the mirrors 255 are formed, light propagating through the optical waveguide core 250 can be extracted almost perpendicularly to the surface of the flexible optoelectronic interconnection board 200, and light having almost perpendicularly entered the surface of the flexible optoelectronic interconnection board 200 can be coupled with the optical waveguide core 250. The 45° mirrors 255 can be formed by, e.g., laser abrasion, dicing, or molding, and a metal (e.g., Au) may be deposited on the mirror surfaces in order to increase the reflectivity. Note that the angle (with respect to the light propagating direction) of the 45° mirrors 255 need not accurately be 45°, but desirably falls within the effective range of 30° to 60°.

The optical semiconductor element 280 is a light-emitting element or light-receiving element formed on, e.g., a GaAs substrate, and has a light emission or light reception wavelength of, e.g., 850 nm. It is possible to use, e.g., a vertical cavity surface emitting laser (VCSEL) as the light-emitting element 280a, and a PIN photodiode (PD) as the light-receiving element 280b. Note that the optical semiconductor element 280 can also be formed on a substrate made of, e.g., a compound semiconductor (e.g., GaAlAs/GaAs, InGaAs/InP, or SiGe), Si, or Ge, and the light emission or light reception wavelength can appropriately be changed as needed. The optical semiconductor element 280 may be an array chip in which a plurality of optical elements are formed in one chip, or an optical semiconductor element in which both a light-emitting element and light-receiving element are formed. It is also possible to use an optical semiconductor element capable of both light emission and light reception.

The optical semiconductor element 280 is aligned and mounted such that its light-emitting portion or light-receiving portion faces the 45° mirror 255 formed in the optical waveguide core 250. Accordingly, the light-emitting element 280a mounted on one end of the optical waveguide core 250 and the light-receiving element 280b mounted on the other end of the optical waveguide core 250 optically couple with each other through the optical waveguide core 250, and can perform optical signal transmission between one end and the other of the flexible optoelectronic interconnection module. Also, the optical semiconductor element 280 is electrically connected to the electrical wire 220 via the Au bump 282 formed on the optical semiconductor element 280, and can transmit optical signals by electrical input/output. Examples of the electrical connection method are bump connection using a solder bump, and wire bonding connection.

Referring to FIG. 1A, one light-emitting element 280a is mounted on one end of the flexible optoelectronic interconnection board 200, and one light-receiving element 280b is mounted on the other end. However, it is also possible to further mount another optical semiconductor element. In FIG. 1A, the optical signal transmission direction is one direction from one end to the other of the flexible optoelectronic interconnection board 200. However, it is also possible to mount a light-receiving element on one end and a light-emitting element on the other end, and perform optical signal transmission in a direction opposite to that shown in FIG. 1A. Furthermore, bidirectional optical signal transmission may be performed by mounting a light-emitting element and light-receiving element on one end, and a light-receiving element and light-emitting element on the other end.

The driving ICs 281 (281a and 281b) are electrically connected to the electrical wires 220 via the Au bumps 282 formed on the driving ICs 281. The driving IC 281a supplies a bias current and drive current to the light-emitting element 280a in accordance with an electrical input signal. The driving IC 281b applies a reverse bias voltage to the light-receiving element 280b, and generates an electrical output signal by amplifying a light reception current generated by the light-receiving element 280b. Note that the driving IC 281 may have the functions of both the driving ICs 281a and 281b. The driving IC 281 can further have other circuit functions such as a serialize function of converting a parallel electrical signal into a serial electrical signal, and a deserialize function of converting a serial electrical signal into a parallel electrical signal. A plurality of electrical input signals can be transmitted as they are converted into fewer optical signals by installing the serialize function in the driving IC 281a for the light-emitting element 280a described above, and the deserialize function in the driving IC 281b for the light-receiving element 280b described above.

The underfill resin 290 is, e.g., an epoxy-based resin. The underfill resin 290 is applied on the bottom surfaces and side surfaces of the optical semiconductor element 280 and driving IC 281, and solidified by heating or ultraviolet irradiation. The underfill resin 290 can reliably hold the electrical connection between the electrical wire 220 and the optical semiconductor element 280 and driving IC 281. The underfill resin 290 can also increase the optical coupling efficiency by filling the space formed between the optical semiconductor element 280 and optical waveguide core 250, and suppress the reflection of light in the space formed between the optical semiconductor element 280 and optical waveguide core 250. This makes high-efficiency, high-reliability optical coupling feasible. Note that different resins may be used as an underfill resin to be filled in the space formed between the optical semiconductor element 280 and optical waveguide core 250, and an underfill resin to be used to hold the electrical connection between the electrical wire 220 and the optical semiconductor element 280 and driving IC 281. In either case, the underfill resin to be filled in the space formed between the optical semiconductor element 280 and optical waveguide core 250 is desirably transparent with respect to the optical transmission wavelength.

The bonding wires 310 electrically connect the first and second electrical connection terminals 130 and 230, and are formed by bonding of wires made of, e.g., Au, Cu, or Al. The use of the wire bonding connection facilitates electrical connection even when there is a step between the first and second electrical connection terminals 130 and 230. Also, the cost decreases because only wires having a small diameter (e.g., a diameter of 20 μm) are used as connecting members, and high-throughput electrical connection is possible because the manufacturing technique has matured.

The mold resin 320 is made of, e.g., an epoxy-based resin, and is capable of reliably holding the electrical connection between the bonding wire 310 and the first and second electrical connection terminals 130 and 230. In addition, as shown in FIG. 1A, the mold resin 320 may be applied to a broad range including the portion where the optical semiconductor element 280 and driving IC 281 are mounted, and the portion of the flexible wiring board 100 where the flexible optoelectronic interconnection board 200 is mounted. Furthermore, the mold resin 320 may be applied to completely cover the upper surfaces of the optical semiconductor element 280 and driving IC 281. This makes it possible to strongly fix the flexible optoelectronic interconnection board 200 and flexible wiring board 100, and protect the optical semiconductor element 280 and driving IC 281 against, e.g., an external shock.

The stiffening plates 330 are made of, e.g., polyimide or PET having a thickness of, e.g., 200 μm. Each stiffening plate 330 is formed on that surface of the flexible wiring board 100, which is opposite to the surface facing the flexible optoelectronic interconnection board 200, in order to stiffen the region where the first and second electrical connection terminals 130 and 230 are formed, and the region where the optical semiconductor element 280 and driving IC 281 are mounted, in the flexible optoelectronic interconnection module.

For example, when the flexible optoelectronic interconnection module flexes due to a temperature change or bending of the module, a stress sometimes acts on the connecting portions between the bonding wire 310 and the first and second electrical connection terminals 130 and 230, or the connecting portions between the flexible optoelectronic interconnection board 200 and the optical semiconductor element 280 and driving IC 281, thereby breaking or damaging the connecting portion. This embodiment can prevent the above-mentioned connecting portions from being broken or damaged, by forming the stiffening plates 330. Note that the stiffening plate 330 may be sandwiched between the flexible wiring board 100 and flexible optoelectronic interconnection board 200. Note also that the stiffening plate 330 desirably has rigidity higher than those of the flexible wiring board 100 and flexible optoelectronic interconnection board 200.

The stiffening plate 330 need not be used if the stress to be applied to the connecting portions between the bonding wire 310 and the first and second electrical connection terminals 130 and 230 or to the connecting portions between the flexible optoelectronic interconnection board 200 and the optical semiconductor element 280 and driving IC 281 is sufficiently suppressed, so the possibility that the connecting portions are broken or damaged is low.

The adhesive sheet 300 adheres and fixes the flexible wiring board 100 and flexible optoelectronic interconnection board 200. As the adhesive sheet 300, it is possible to use a material obtained by molding an adhesive agent made of, e.g., an epoxy-based resin, acryl-based resin, or polyester-based resin into the shape of a sheet. As the adhesive sheet 300, it is also possible to use, e.g., a material obtained by forming adhesive layers made of the above-mentioned adhesive agent on the two surfaces of a base made of a resin film of, e.g., polyimide or a metal foil of Al, Cu, or the like. The thickness of the adhesive sheet 300 is, e.g., 50 μm. Note that in FIG. 1A, the adhesive sheets 300a and 300b are formed near the portions where the optical semiconductor elements 280 and driving ICs 281 are mounted, at the two ends of the flexible optoelectronic interconnection board 200. However, this embodiment is not limited to this. For example, one adhesive sheet extending from one end to the other of the flexible optoelectronic interconnection board may be used instead of the adhesive sheets 300a and 300b. Also, no adhesive sheet 300 need be used if the mold resin 320 alone can fix the flexible wiring board 100 and flexible optoelectronic interconnection board 200.

In this embodiment as described above, the flexible optoelectronic interconnection board 200 in which the electrical wires 220 and optical waveguide cores 250 are aligned and integrated and which has a minimum necessary size is mounted on the flexible wiring board 100 such that the first and second electrical connection terminals 130 and 230 point in the direction of the same plane, and the first and second electrical connection terminals 130 and 230 are electrically connected by wire bonding. This makes it possible to provide a flexible optoelectronic interconnection module by reducing the member cost. In addition, since the optical semiconductor elements 280 are mounted in alignment with the optical waveguide cores 250, it is possible to provide a flexible optoelectronic interconnection module by improving the reliability against temperature fluctuations and the like.

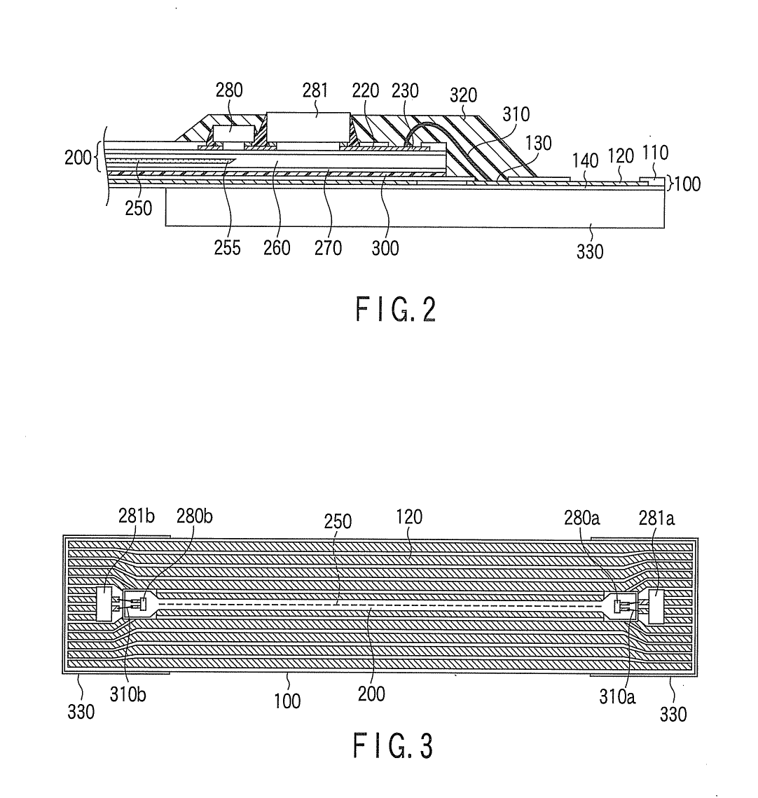

Note that the mold resin 320 need not always cover the upper surfaces of the optical semiconductor element 280 and driving IC 281, and the upper surface of the driving IC 281 may be exposed as shown in FIG. 2. In this case, a heat sink (not shown) can be connected to the upper surface of the driving IC 281. Generally, the driving IC 281 generates more heat than the optical semiconductor element 280, so it is extremely effective to cool the driving IC by the heat sink.

Note also that the driving ICs 281 need not always be mounted on the flexible optoelectronic interconnection board 200, and may be mounted on the flexible wiring board 100 as shown in FIG. 3. In this case, the optical semiconductor elements 280 and driving ICs 281 are connected by connecting members (e.g., bonding wires). Generally, the size of the driving IC 281 is larger than that of the optical semiconductor element 280 (in this embodiment, the driving IC size is 1 mm×1 mm, and the optical semiconductor element size is 300 μm×300 μm), so the maximum width of the flexible optoelectronic interconnection board 200 cannot be smaller than the size of the driving IC 281. When the driving ICs 281 are mounted on the flexible optoelectronic interconnection board 200, however, it is possible to decrease the maximum width of the flexible optoelectronic interconnection board 200, and further reduce the cost.

### Second Embodiment

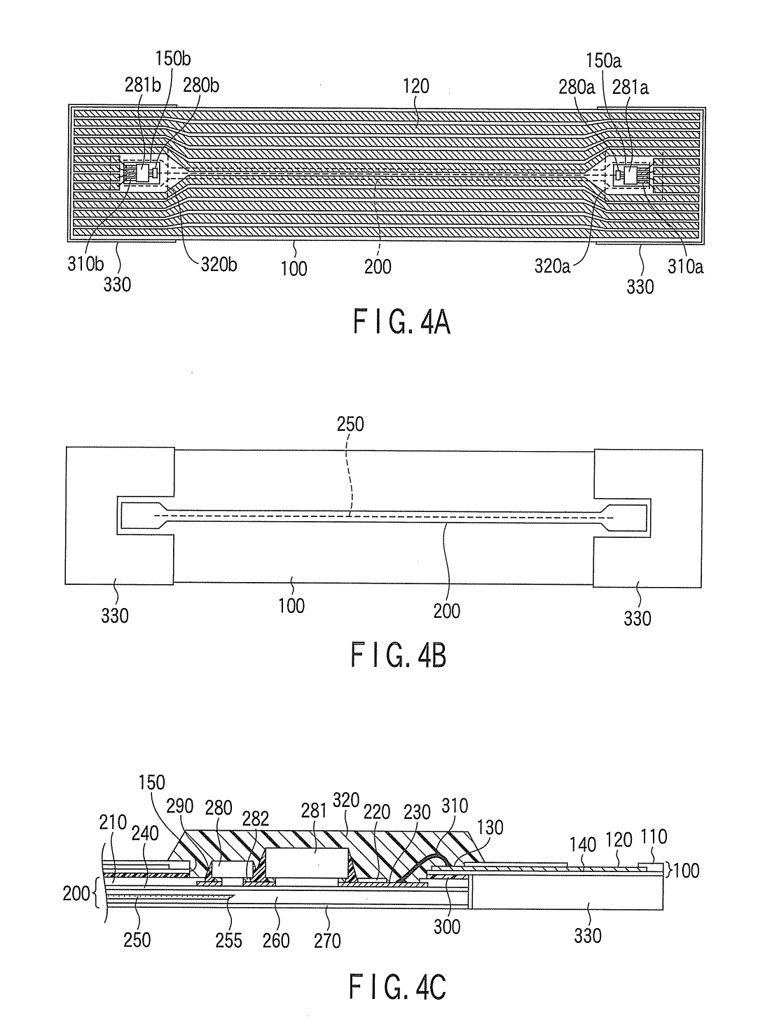

FIGS. 4A, 4B, and 4C are views for explaining an arrangement of a flexible optoelectronic interconnection module according to the second embodiment. FIG. 4A is a plan view of the flexible optoelectronic interconnection module, FIG. 4B is a bottom view of the module, and FIG. 4C is a sectional view (in a wiring direction) of an optical semiconductor element mounting portion and vicinity of the module. Note that the same reference numerals as in FIGS. 1A, 1B, and 1C denote the same parts, and a repetitive explanation will be omitted.

In this embodiment, the thickness of the flexible optoelectronic interconnection module is made smaller than that of the embodiment shown in FIGS. 1A, 1B, and 1C.

In this embodiment, through holes 150 (150a and 150b) (the width is, e.g., 1.2 mm, and the length is, e.g., 2.0 mm) are formed in a flexible wiring board 100, and a flexible optoelectronic interconnection board 200 is mounted from below the flexible wiring board 100 (from the lower side in FIG. 4C). Optical semiconductor elements 280 and driving ICs 281 mounted on the flexible optoelectronic interconnection board 200 and second electrical connection terminals 230 formed on the flexible optoelectronic interconnection board 200 are arranged in the through holes 150. When compared to the first embodiment, therefore, the thickness of the flexible optoelectronic interconnection module can be decreased by the sum of the thickness of an adhesive sheet 300 and that of the flexible optoelectronic interconnection board 200. Accordingly, this embodiment can contribute to the downsizing and thinning of an electronic apparatus using this module.

Note that the through holes 150 can be formed by, e.g., laser processing, mold punching, or router processing as mechanical cutting.

Also, in this embodiment, the height of the surface on which first electrical connection terminals 130 are formed and the surface on which the second electrical connection terminals 230 are formed (the total height of the thicknesses of a base film 140, the adhesive sheet 300, and a cover lay 210 is 100 μm when the thicknesses of all these layers are added up) is smaller than the height of the surface on which the first electrical connection terminals 130 and the surface on which the second electrical connection terminals 230 are formed in the embodiment shown in FIGS. 1A, 1B, and 1C (the total height of the thicknesses of the base film 240, optical waveguide clad 260, cover layer 270, and adhesive sheet 300 is 150 μm when the thicknesses of all these layers are added up). Since this can make the length of bonding wires 310 shorter than that of the first embodiment, the cost of the flexible optoelectronic interconnection module can be reduced. This effect can be expected especially when mass-producing the flexible optoelectronic interconnection modules.

In this flexible optoelectronic interconnection module, the flexible optoelectronic interconnection board 200 is mounted from below the flexible wiring board 100 (from the lower side in FIG. 4C), and this produces a step between the lower surface of the flexible optoelectronic interconnection board 200 and the lower surface of the flexible wiring board 100. As shown in FIG. 4B, therefore, each stiffening plate 330 desirably has a shape from which the mounting portion of the flexible optoelectronic interconnection board 200 is removed. This makes it possible to make the distance between the first electrical connection terminals 130 and the second electrical connection terminals 230 small. Also, as shown in FIG. 4C, the stiffening plate 330 desirably has a thickness larger than the total thickness of the adhesive sheet 300 and flexible optoelectronic interconnection board 200, so that the lower surface (the lower surface in the sectional view of FIG. 10) of the stiffening plate 330 is lower than the lower surface of the flexible optoelectronic interconnection board 200. This makes it possible to prevent the flexible optoelectronic interconnection board 200 from being caught by an external structure to break or damage the connection between the flexible optoelectronic interconnection board 200 and flexible wiring board 100.

In this embodiment as described above, the flexible optoelectronic interconnection board 200 is mounted on the flexible wiring board 100 in which the through holes 150 are formed, and the optical semiconductor elements 280 and driving ICs 281 mounted on the flexible optoelectronic interconnection board 200 and the second electrical connection terminals 230 formed on the flexible optoelectronic interconnection board 200 are arranged in the through holes 150. Accordingly, it is possible to provide a flexible optoelectronic interconnection module by reducing the thickness and cost.

### Third Embodiment

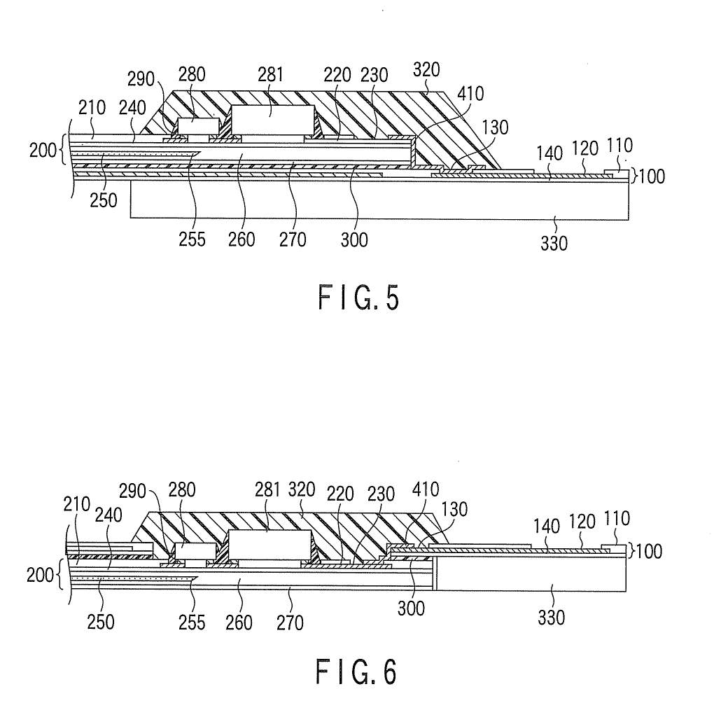

FIG. 5 is a view for explaining an arrangement of a flexible optoelectronic interconnection module according to the third embodiment, i.e., a sectional view (in a wiring direction) of an optical semiconductor element mounting portion and vicinity. Note that the same reference numerals as in FIGS. 1A, 1B, and 10 denote the same parts, and a repetitive explanation will be omitted.

In this embodiment, the height of an interconnection for electrically connecting first and second electrical connection terminals 130 and 230 is decreased.

In the flexible optoelectronic interconnection module of this embodiment, the second electrical connection terminal 230 of a flexible optoelectronic interconnection board 200 and the first electrical connection terminal 130 of a flexible wiring board 100 are connected by an inkjet interconnection 410. The inkjet interconnection, that is, conducting layer is formed by applying the inkjet technique used in printing, i.e., drawn on a substrate by discharging a liquid containing a conductive material (e.g., Au or Ag nanoparticles). Note that annealing for increasing the conductivity may be performed after the interconnection is drawn. Note also that the inkjet interconnection 410 is desirably protected by a mold resin 320, as shown in FIG. 5.

The bonding wires 310 used to connect the first and second electrical connection terminals 130 and 230 in FIGS. 1A, 1B, 10, 2A, and 2B form a aerial wiring having no support member except for the connecting portions of the first and second electrical connection terminals 130 and 230. Before the interconnect is protected by the mold resin, therefore, the connection may be broken when it comes in contact with an external structure. By contrast, the inkjet interconnection 410 is directly formed on the flexible optoelectronic interconnection board 200 and flexible wiring board 100, and the height of the interconnection can be decreased. This improves the reliability of the connection.

Note that the inkjet interconnection is also applicable to the flexible optoelectronic interconnection module shown in FIGS. 4A, 4B, and 4C. FIG. 6 is a view for explaining an arrangement of a flexible optoelectronic interconnection module according to the third embodiment, which is different from that shown in FIGS. 4A, 4B, and 4C, i.e., a sectional view (in the wiring direction) of an optical semiconductor element mounting portion and vicinity of the flexible optoelectronic interconnection module.

As described above, this embodiment can provide a highly reliable flexible optoelectronic interconnection module by electrically connecting the first and second electrical connection terminals 130 and 230 by using the inkjet interconnection 410.

### Fourth Embodiment

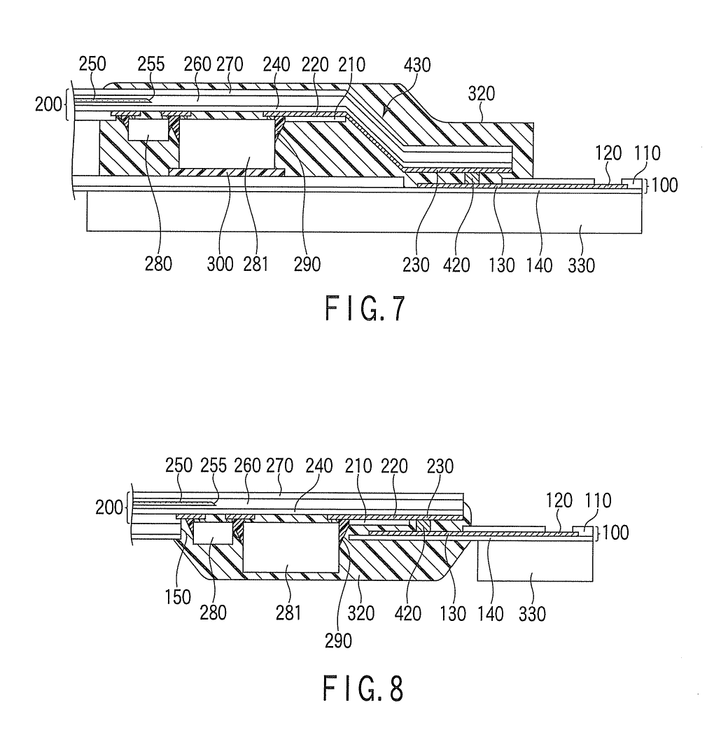

FIG. 7 is a view for explaining an arrangement of a flexible optoelectronic interconnection module according to the fourth embodiment, i.e., a sectional view (in a wiring direction) of an optical semiconductor element mounting portion and vicinity of the module. Note that the same reference numerals as in FIGS. 1A, 1B, and 1C denote the same parts, and a repetitive explanation will be omitted.

In this embodiment, the electrical connection between first and second electrical connection terminals 130 and 230 can be formed with a throughput higher than those of the first and second embodiments.

In the flexible optoelectronic interconnection module of this embodiment, a flexible optoelectronic interconnection board 200 is mounted on a flexible wiring board 100 such that the surface of the flexible optoelectronic interconnection board 200 on which the second electrical connection terminals 230 are formed faces the surface of the flexible wiring board 100 on which the first electrical connection terminals 130 are formed. The first and second electrical connection terminals 130 and 230 are electrically connected by a bump 420.

As the bump 420, it is possible to use, e.g., an Au stud bump, Au plated bump, or solder bump. A connection method using the bump 420 is as follows. That is, a necessary number of bumps 420 are preformed on the first or second electrical connection terminal 130 or 230. Subsequently, the region of the flexible optoelectronic interconnection board 200 in which the second electrical connection terminal 230 is formed and the region of the flexible wiring board 100 in which the first electrical connection terminal 130 is formed are opposed to each other and aligned with each other. After that, heat or an ultrasonic wave is applied while a pressure is applied to the region of the flexible optoelectronic interconnection board 200 in which the second electrical connection terminal 230 is formed and the region of the flexible wiring board 100 in which the first electrical connection terminal 130 is formed. This makes it possible to electrically connect the first and second electrical connection terminals 130 and 230 by the bumps 420.

When connecting the first and second electrical connection terminals 130 and 230 by using the bonding wires 310 in the first and second embodiments, wire bonding must be performed a number of times equal to the number of first or second electrical connection terminals 130 or 230. By contrast, a plurality of first electrical connection terminals 130 and a plurality of second electrical connection terminals 230 can electrically be connected at once by using the bumps 420. Accordingly, the throughput of the electrical connection between the first and second electrical connection terminals 130 and 230 can be increased. Furthermore, since the first and second electrical connection terminals 130 and 230 is connected by the bumps 420, the length of conductive connection member is shorter than that of the first and second embodiments in which the first and second electrical connection terminals 130 and 230 is connected by the bonding wires 310. Therefore, the cost of the conductive connection member can be decreased. Note that after the first and second electrical connection terminals 130 and 230 are connected by using the bumps 420, the connecting portions are desirably protected with a mold resin 320. Note also that a plurality of bumps 420 can be used to electrically connect one first electrical connection terminal 130 and one second electrical connection terminal 230.

Since the flexible optoelectronic interconnection board 200 is mounted on the flexible wiring board 100 such that the surface on which optical semiconductor elements 280 and driving ICs 281 are mounted is opposed to the flexible wiring board 100, the first and second electrical connection terminals 130 and 230 are spaced apart by the height of the driving IC 281 (in the above-described embodiment, 300 μm). In the flexible optoelectronic interconnection module shown in FIG. 7, therefore, the second electrical connection terminal 230 is positioned close to the first electrical connection terminal 130 by forming a bent portion 430 on the flexible optoelectronic interconnection board 200. This facilitates electrically connecting the first and second electrical connection terminals 130 and 230. Since the bent portion 430 produces a stress in the flexible optoelectronic interconnection board 200, however, it is desirable to fix, with the mold resin 320, the region including the portion and vicinity of the flexible optoelectronic interconnection board 200 where the optical semiconductor element 280 and driving IC 281 are mounted, and the portion and vicinity of the flexible wiring board 100 where the flexible optoelectronic interconnection board 200 is mounted.

An adhesive sheet 300 for fixing the flexible wiring board 100 and flexible optoelectronic interconnection board 200 is formed in the contact portion between the driving IC 281 and flexible wiring board 100. Therefore, the adhesive sheet 300 is desirably an adhesive sheet having a high thermal conductivity (e.g., an adhesive sheet having a thermal conductivity higher than the average thermal conductivity in the thickness direction of the flexible optoelectronic interconnection board 200 or flexible wiring board 100), so as to be able to radiate heat generated by the driving IC 281 to the flexible wiring board 100. Furthermore, the surface of the flexible wiring board 100 with which the driving IC 281 comes in contact is desirably a metal region formed by patterning electrical wires 120 into islands, so as to be able to efficiently radiate heat generated by the driving IC 281 to the flexible wiring board 100. When the flexible wiring board 100 is a multilayered wiring board, the efficiency of heat radiation can further be increased by connecting the metal region to the ground or a power supply through a via. Note that no adhesive sheet 300 need be used if the flexible wiring board 100 and flexible optoelectronic interconnection board 200 can be fixed without any adhesive sheet, or if heat radiation from the driving IC 281 is unnecessary.

In this embodiment as described above, the flexible optoelectronic interconnection board 200 is mounted on the flexible wiring board 100 with the first and second electrical connection terminals 130 and 230 being opposed to each other, and the first and second electrical connection terminals 130 and 230 are electrically connected by the bumps 420. This makes it possible to provide a flexible optoelectronic interconnection module that can be manufactured with a high throughput and low cost.

### Fifth Embodiment

FIG. 8 is a view for explaining an arrangement of a flexible optoelectronic interconnection module according to the fifth embodiment, i.e., a sectional view (in a wiring direction) of an optical semiconductor element mounting portion and vicinity of the module. Note that the same reference numerals as in FIGS. 1A, 1B, and 1C denote the same parts, and a repetitive explanation will be omitted.

In this embodiment, the thickness of the flexible optoelectronic interconnection module is made smaller than that of the fourth embodiment.

In the flexible optoelectronic interconnection module of this embodiment, a through hole 150 (the width is, e.g., 1.2 mm, and the length is, e.g., 2.0 mm) is formed in a flexible wiring board 100, and an optical semiconductor element 280 and driving IC 281 mounted on a flexible optoelectronic interconnection board 200 are arranged in the through hole 150.

This obviates the need for the bent portion 430 for positioning first and second electrical connection terminals 130 and 230 close to each other. Since this eliminates the stress produced in the flexible optoelectronic interconnection board 200, the electrical connection between the first and second electrical connection terminals 130 and 230 can reliably be held. In addition, the strain produced in the flexible optoelectronic interconnection board 200 disappears. This makes it possible to suppress, e.g., the deterioration of electrical wires 220 and optical waveguide cores 250 with time. Furthermore, the thickness of the flexible optoelectronic interconnection module can be made smaller by about the thickness of the driving IC 281 (in this embodiment, 300 μm) than that of the fourth embodiment. This can contribute to the downsizing and thinning of an electronic apparatus using this module.

In this embodiment as described above, the through hole 150 is formed in the flexible wiring board 100, and the optical semiconductor element 280 and driving IC 281 mounted on the flexible optoelectronic interconnection board 200 are arranged in the through hole 150. Since this makes the bent portion 430 unnecessary, it is possible to provide a flexible optoelectronic interconnection module by reducing the thickness and improving the reliability.

### Sixth Embodiment

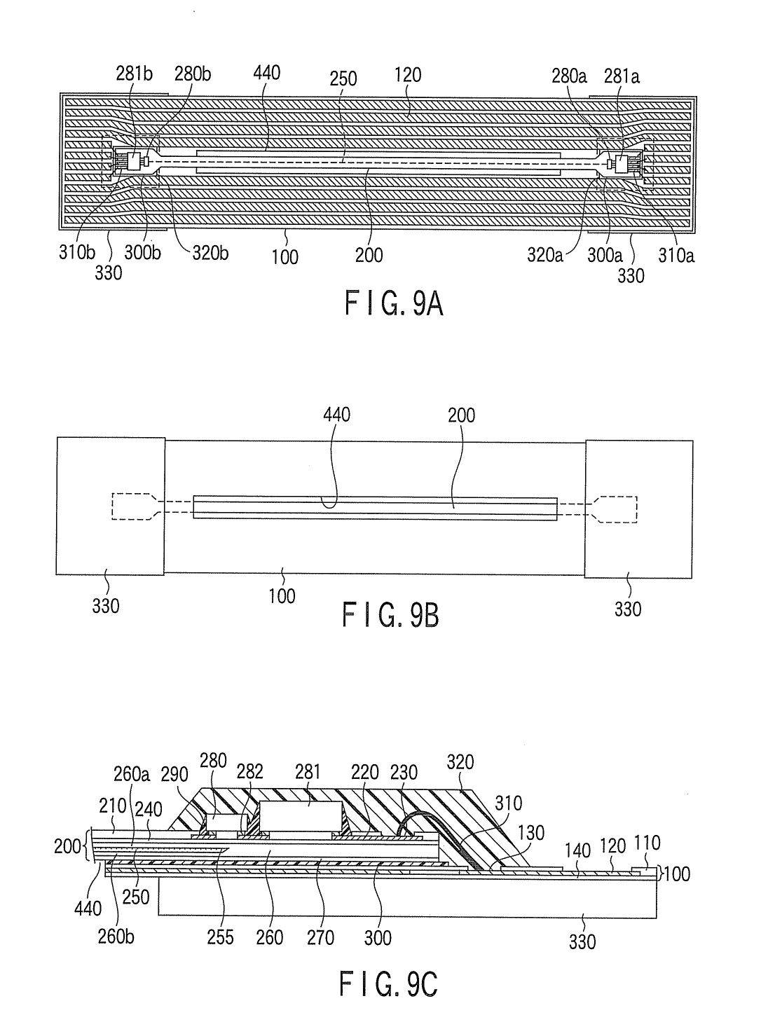

FIGS. 9A, 9B, and 9C are views for explaining an arrangement of a flexible optoelectronic interconnection module according to the sixth embodiment. FIG. 9A is a plan view of the flexible optoelectronic interconnection module, FIG. 9B is a bottom view of the module, and FIG. 9C is a sectional view of the module. Note that the same reference numerals as in FIGS. 1A, 1B, and 1C denote the same parts, and a repetitive explanation will be omitted.

This embodiment is directed to a flexible optoelectronic interconnection module obtained by modifying the flexible wiring board 100 in each of the above-mentioned embodiments. In this embodiment, the bending properties of the flexible optoelectronic interconnection module are improved compared to those of the first to fifth embodiments.

In the flexible optoelectronic interconnection module of this embodiment, in an interconnection region connecting the end regions (regions where first and second electrical connection terminals 130 and 230 are formed and regions where optical semiconductor elements 280 and driving ICs 281 are mounted) of the flexible optoelectronic interconnection module, a through hole 440 (e.g., the width is 1.2 mm) having a width larger than the width (in the vertical direction of the drawing surface of FIG. 9A, 1.0 mm in this embodiment) of the interconnection region of a flexible optoelectronic interconnection board 200 is formed in a flexible wiring board 100. The flexible optoelectronic interconnection board 200 is mounted on the flexible wiring board 100 such that portions the flexible optoelectronic interconnection module 200 are arranged in the through hole 440.

Consequently, the thickness of the interconnection region of the flexible optoelectronic interconnection module can effectively be decreased. This makes it possible to decrease the minimum bending radius when bending (e.g., performing a folding action or sliding action) the interconnection region of the flexible optoelectronic interconnection module. Also, the flexible optoelectronic interconnection board 200 and flexible wiring board 100 do not overlap each other in the interconnection region of the flexible optoelectronic interconnection module, and do not rub each other when flexed. This increases the durability against repetitive flexing.

Note that the through hole 440 need only be formed in at least a portion below the interconnection region of the flexible optoelectronic interconnection board 200. Therefore, the size and position of the through hole 440 can appropriately be changed, and a plurality of through holes 440 may be formed. In addition, the same effect as that when forming the through hole 440 can be obtained by partially decreasing the thickness of the flexible wiring board 100 by, e.g., partially removing a cover lay 110, instead of forming the through hole 440.

In this embodiment as described above, the through hole 440 is formed in the flexible wiring board 100, and the flexible optoelectronic interconnection board 200 is mounted so as to be placed in the through hole 440. Accordingly, a flexible optoelectronic interconnection module having improved bending properties can be provided.

### Seventh Embodiment

FIG. 10 is a plan view showing an arrangement of a flexible optoelectronic interconnection module according to the seventh embodiment. Note that FIG. 10 shows only a flexible wiring board 100 and flexible optoelectronic interconnection board 200, and does not show the rest.

In this embodiment, the twisting properties of the interconnection region of the flexible optoelectronic interconnection module are improved.

In the flexible optoelectronic interconnection module of this embodiment, the wiring region of the flexible wiring board 100 is divided into a plurality of thin lines (the width is, e.g., 1 mm) by forming through holes 440 (the width is, e.g., 0.1 mm) parallel to the wiring direction of the flexible wiring board 100. The flexible optoelectronic interconnection board 200 is mounted on one of the divided thin lines.

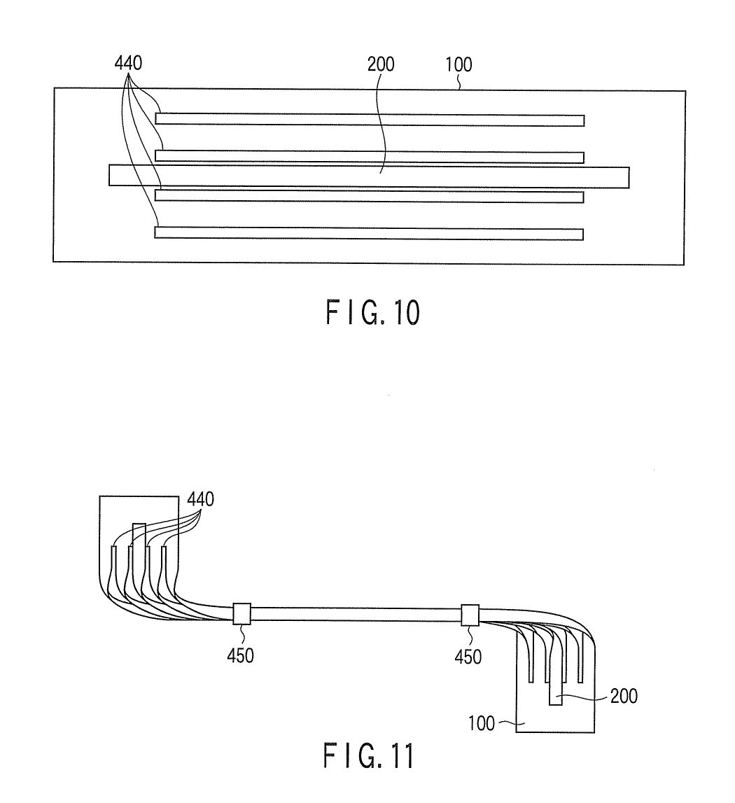

In the flexible optoelectronic interconnection module shown in FIG. 10, one end region, the wiring region, and the other end region of the flexible optoelectronic interconnection module are arranged into the shape of a crank, as shown in FIG. 11. The plurality of thin lines are overlaid such that the upper surface of each thin line faces the lower surface of an adjacent thin line, and bound by using binding bands 450. Accordingly, the wiring region can be handled as one thin flexible wiring board. This makes it possible to resist against, e.g., a rotating action and twisting action, in addition to a bending action.

Note that all the thin lines desirably have almost equal widths and spacings. This is so because tension does not concentrate in the thin lines when the flexible optoelectronic interconnection module is formed into the crank shape as described above, and the plurality of thin lines are overlaid such that the upper surface of each thin line faces the lower surface of an adjacent thin line. Also, since all of the plurality of thin lines are equally pulled, the alignment of the plurality of thin lines in the region where they are bound is good, and no thin lines are unbound. Note that the thin lines of the flexible optoelectronic interconnection module may be overlaid by another method (e.g., a plurality of thin lines are overlaid such that the upper surface of each thin line faces the upper surface of an adjacent line, or the lower surface of each thin line faces the lower surface of an adjacent thin line).

As the binding band 450, it is possible to use, e.g., a fluorine-resin-based seal tape. It is desirable to use a tape containing no adhesive as the binding band 450 and allow each thin line to move inside the binding band, in order to remove the slack and stress of the thin lines. Note that the number of binding bands 450 can appropriately be changed as needed. It is also possible to use a continuous binding band extending from one end to the other of the bound thin lines, instead of separated binding bands. Furthermore, no binding bands 450 need be used if there is no possibility that a plurality of bound thin lines are unbound, or if a plurality of bound thin lines can be unbound. It is desirable to form no electrical wires in portions where the through holes 440 are to be formed.

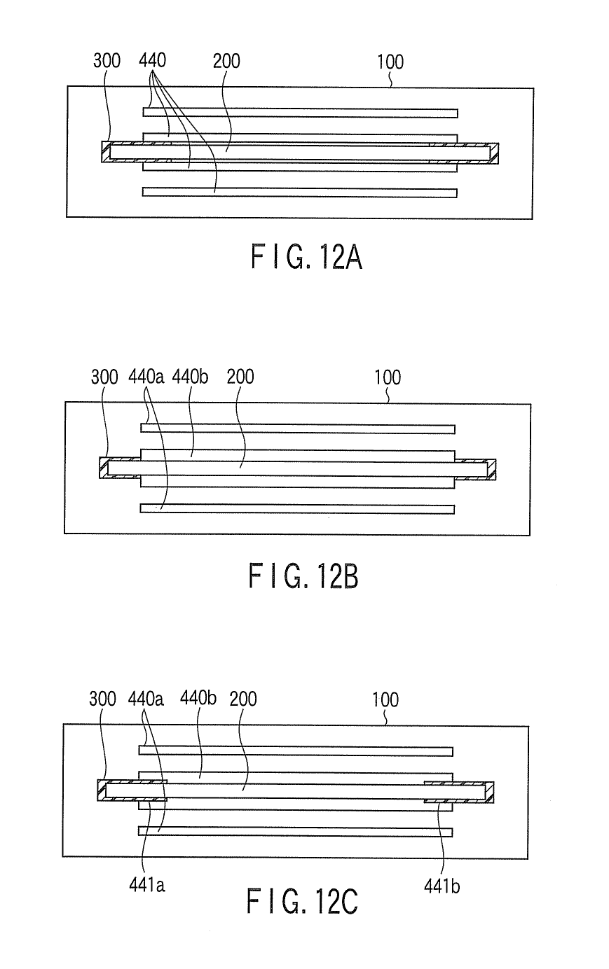

Note that when connecting the flexible wiring board 100 and flexible optoelectronic interconnection board 200, the entire surface of the flexible optoelectronic interconnection board 200 need not be adhered, and only the end regions of the flexible optoelectronic interconnection board 200 may be adhered by adhesive sheets 300, as shown in FIG. 12A.

In the region where the flexible optoelectronic interconnection board 200 is to be placed, as shown in FIG. 12B, a through hole 440b having a width (e.g., 1.2 mm) larger than that of the interconnection region of the flexible optoelectronic interconnection board 200 may be formed in the flexible wiring board 100, as in the sixth embodiment. That is, it is possible to form a through hole by connecting two through holes 440 adjacent to the flexible optoelectronic interconnection board 200 shown in FIG. 10. In this case, as in the sixth embodiment, it is possible to decrease the minimum bending radius when bending (e.g., performing a folding action or sliding action) the interconnection region of the flexible optoelectronic interconnection module. It is also possible to eliminate rubbing between the flexible optoelectronic interconnection board and flexible wiring board, and increase the durability against repetitive flexing.

In the arrangement shown in FIG. 12B, however, when a plurality of thin lines of the flexible optoelectronic interconnection module are bound as shown in FIG. 11, the flexible optoelectronic interconnection board 200 flexes, and the stress that peels off the flexible optoelectronic interconnection board 200 from the flexible wiring board 100 is generated in the boundary portion between the flexible optoelectronic interconnection board 200 and through hole 440b. As shown in FIG. 12C, therefore, it is possible to form projections 441 (441a and 441b) in the through hole 440b by projecting the flexible wiring board 100 in the end regions of the flexible optoelectronic interconnection board 200, and adhere the flexible optoelectronic interconnection board 200 to the projections 441 as well. In this case, the stress generated by the above-described flexing acts on the roots of the projections 441 of the flexible wiring board 100, and this makes it possible to reduce the stress applied to the boundary portion between the flexible optoelectronic interconnection board 200 and through hole 440b. Accordingly, the reliability of the adhesion between the flexible wiring board 100 and flexible optoelectronic interconnection board 200 can be improved. Note that as in the arrangement shown in FIG. 12B, it is possible to decrease the minimum bending radius of the flexible optoelectronic interconnection module and increase the durability against repetitive flexing in the arrangement shown in FIG. 12C as well.

As described above, this embodiment can provide a flexible optoelectronic interconnection module having improved twisting properties by dividing the wiring region of the flexible wiring board 100 into a plurality of thin lines, mounting the flexible optoelectronic interconnection board 200 on a divided thin line, and overlaying and binding the thin lines.

### Eighth Embodiment

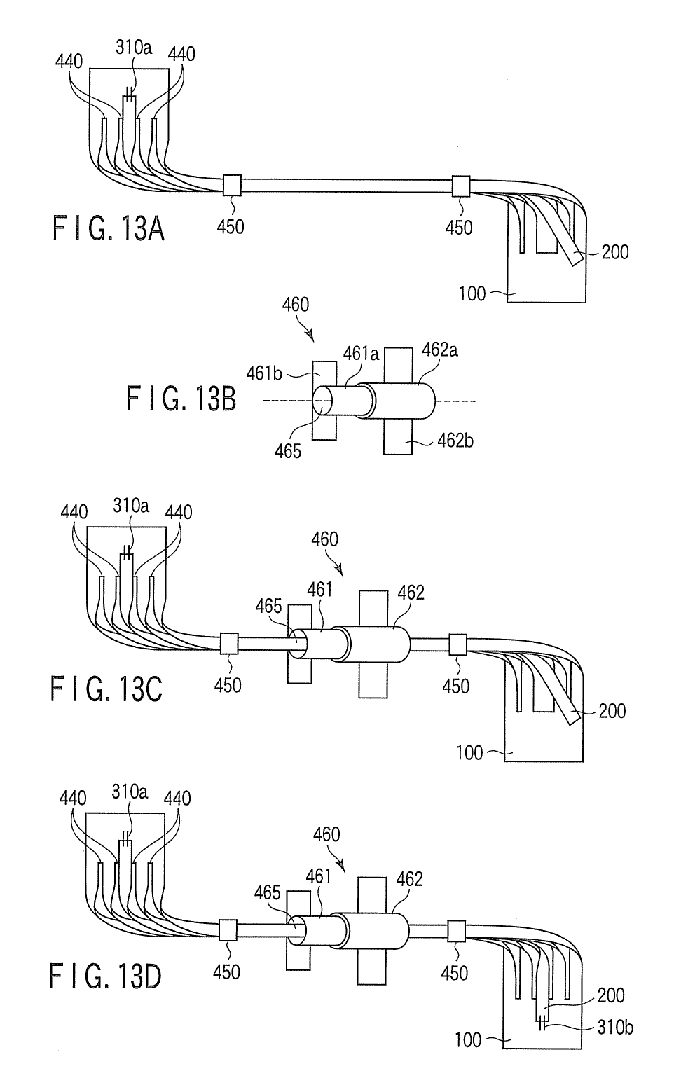

FIGS. 13A, 13B, 13C, and 13D are views showing a method of manufacturing a flexible optoelectronic interconnection module according to the eighth embodiment.

First, as shown in FIG. 13A, the flexible optoelectronic interconnection module shown in FIG. 11 is prepared. At one end of the flexible optoelectronic interconnection module, a flexible optoelectronic interconnection board 200 is mounted on and fixed to a flexible wiring board 100, and first and second electrical connection terminals 130 and 230 are electrically connected by a bonding wire 310a. At the other end of the flexible optoelectronic interconnection module, the flexible optoelectronic interconnection board 200 is not mounted on the flexible wiring board 100.

Also, as shown in FIG. 13B, a movable part (locking member) 460 including a through hole having a diameter larger than the wiring portion of the flexible optoelectronic interconnection module shown in FIG. 13A is prepared.

The movable part 460 is an integrated part including at least two parts, i.e., parts 461 and 462, and has an internal interconnection path 465. The interconnection path 465 has, e.g., a cylindrical shape, and has a diameter of, e.g., 1.6 mm. The two parts 461 and 462 can independently rotate around the central axis (the broken line in FIG. 13B) of the movable part 460. The part 461 includes a cylinder 461a, and a blade 461b for fixing the cylinder 461a to a packaging substrate. The part 462 includes a cylinder 462a, and a blade 462b for fixing the cylinder 462a to a packaging substrate. The cylinder 461a is rotatably inserted into the cylinder 462a. Accordingly, the packaging substrate fixed to the blade 461b can be rotated with respect to the packaging substrate fixed to the blade 462b. An example of the movable part 460 is a hinge part for connecting the main body and display housing of a cell phone or notebook PC.

Then, as shown in FIG. 13C, the flexible optoelectronic interconnection module shown in FIG. 13A is inserted from the other end into the interconnection path 465 of the movable part 460. Since the width (in the above-described embodiment, 10 mm) of the end region of the flexible wiring board 100 is larger than the diameter (in this embodiment, 1.6 mm) of the interconnection path 465, the end region of the flexible wiring board 100 must be inserted into the movable part 460 after being folded or rounded. On the other hand, the width (in the above-described embodiment, the maximum width is 1.5 mm) of the flexible optoelectronic interconnection board 200 is smaller than the diameter of the interconnection path 465, so the flexible optoelectronic interconnection board 200 can easily be inserted into the interconnection path 465. Also, the width (in the above-described embodiment, 1 mm) of the thin line of the flexible wiring board 100 is smaller than the diameter of the interconnection path 465. Therefore, after the end region of the flexible wiring board 100 is inserted into the movable part 460, the interconnection region of the flexible optoelectronic interconnection module in which the thin lines are overlaid and bound can easily be inserted into the movable part 460.

Subsequently, as shown in FIG. 13D, at the other end of the flexible optoelectronic interconnection module, the flexible optoelectronic interconnection board 200 is mounted on and fixed to the flexible wiring board 100. In addition, first and second electrical connection terminals (not shown) are electrically connected by a bonding wire 310b.

The manufacturing method described above facilitates inserting the flexible optoelectronic interconnection module into the movable part 460 including the narrow interconnection path 465. For example, in the flexible optoelectronic interconnection module in which the flexible optoelectronic interconnection board 200 is mounted on the flexible wiring board 100 and electrically connected by the bonding wires 310, a large stress is applied to the connecting portions between the flexible optoelectronic interconnection board 200 and flexible wiring board 100 and the connecting portions of the bonding wires 310 if the flexible wiring board 100 is folded or rounded so as to be inserted into the movable part 460. This may break the connections and deteriorate the reliability. By contrast, in the flexible optoelectronic interconnection module before the flexible optoelectronic interconnection board 200 is mounted on and fixed to the flexible wiring board 100, the flexible wiring board 100 can freely be folded or rounded so as to be inserted into the movable part 460. That is, a highly reliable flexible optoelectronic interconnection module can be manufactured by inserting the flexible optoelectronic interconnection board 200 and flexible wiring board 100 into the movable part 460, and then electrically connecting the flexible optoelectronic interconnection board 200 and flexible wiring board 100.

In the flexible optoelectronic interconnection module of this embodiment, one end is electrically connected beforehand, and the other end is electrically unconnected. However, the both ends can be inserted into the movable part 460 as they are electrically unconnected. In this flexible optoelectronic interconnection module manufacturing method, the thin lines can be bound either before or after the flexible optoelectronic interconnection module is inserted into the movable part 460. Also, the flexible wiring board 100 and flexible optoelectronic interconnection board 200 can simultaneously or separately be inserted. Note that flexible wiring board 100 having no through hole (the flexible wiring board 100 in FIG. 10) can also be used in the flexible optoelectronic interconnection module.

The diameter of the interconnection path 465 of the movable part 460 can be smaller than the maximum width of the flexible optoelectronic interconnection board 200. In this embodiment, the movable part 460 is rotatable around only one axis. However, a movable part rotatable around two or more axes may be used. It is also possible to use a foldable or slidable movable part. Note that the same effect can be obtained even when manufacturing a flexible optoelectronic interconnection module by using an unmovable part including an interconnection. In this embodiment, the bonding wires 310 are used to electrically connect the first and second electrical connection terminals 130 and 230. However, it is also possible to use a different connecting method such as inkjet interconnection or bump connection.

### (Modifications)

The present invention is not limited to the above-described embodiments.

In the first to third embodiments, the first and second electrical connection terminals 130 and 230 are electrically connected by using wire bonding or inkjet interconnection. However, this electrical connection may be performed by using another means. For example, while the flexible wiring board 100 and flexible optoelectronic interconnection board 200 are aligned and fixed, one end of an adhesive film material including preformed electrical wires is placed on the second electrical connection terminal 230, and the other end of the film material is placed on the first electrical connection terminal 130. The first and second electrical connection terminals 130 and 230 can electrically be connected upon applying a pressure. Note that it is also possible to use a film material capable of electrically connecting the first and second electrical connection terminals 130 and 230 when heat or an ultrasonic wave is applied.

In the fourth and fifth embodiments, the first and second electrical connection terminals 130 and 230 are electrically connected by using the bump 420. However, this electrical connection may be performed by using another means. For example, an anisotropic conductive film (ACF) or anisotropic conductive paste (ACP) can be used instead of the bump 420. The ACF is a film material made of a binder resin containing conductive particles. As the conductive particles, it is possible to use, e.g., metal particles, Ni/Au-plated plastic particles, or solder particles. As the binder resin, an epoxy-based resin, acryl-based resin, or the like can be used. When using the ACF as a connecting means, the ACF is placed between the opposing electric terminals, and a pressure is applied between the electric terminals while they are heated. This makes it possible to electrically connect, adhere, and fix only the opposing electric terminals. Since the electrical connection and adhesion/fixing can simultaneously be performed, the connecting portion need not be protected with a mold resin later, and this can reduce the cost of the connecting process.

It is also possible to electrically connect the first and second electrical connection terminals 130 and 230 by directly bonding them. For example, the first and second electrical connection terminals 130 and 230 are plated with solder beforehand, and heated as they are in contact with each other. Consequently, the first and second electrical connection terminals 130 and 230 can electrically be connected by melting the solder. Furthermore, the first and second electrical connection terminals 130 and 230 plated with N/Au can electrically be connected by applying an ultrasonic wave while applying a pressure to them as they are in contact with each other, thereby forming an Au—Au junction.

Although various other methods can be used to electrically connect the first and second electrical connection terminals 130 and 230, the spirit and scope of the invention are not limited to materials and methods used in the electrical connection.

As the light-emitting element as the optical semiconductor element, it is possible to use various light-emitting elements such as a light-emitting diode and semiconductor laser. As the light-receiving element as the optical semiconductor element, it is possible to use various light-receiving elements such as a PIN photodiode, MSM photodiode, avalanche photodiode, and photoconductor. Examples of the flexible wiring board are an FPC and FFC, and the present invention is applicable to both. As the base film of the flexible wiring board, a liquid crystal polymer or another resin can be used instead of polyimide. The electrical wires of the flexible wiring board can be single-layered wires or multilayered wires. The electrical wires and optical interconnections of the flexible optoelectronic interconnection board can be single-layered interconnections and wires or multilayered interconnections and wires.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A flexible optoelectronic interconnection module comprising:
a flexible wiring board including an electrical wire, and a first electrical connection terminal which electrically connects the electrical wire to an external device of the flexible wiring board;
a flexible optoelectronic interconnection board including an optical interconnection path, an
electrical wire, and a second electrical connection terminal which electrically connects the electrical wire to an external device of the flexible optoelectronic interconnection board, and mounted on a partial region of the flexible wiring board;
an optical semiconductor element mounted on the flexible optoelectronic interconnection board, electrically connected to the electrical wire of the flexible optoelectronic interconnection board, and optically coupled with the optical interconnection path; and
a conductive connecting member which is formed between the first electrical connection terminal and the second electrical connection terminal, and electrically connects the first electrical connection terminal and the second electrical connection terminal.

2. The module according to claim 1, wherein a surface of the flexible wiring board on which the first electrical connection terminal is formed and a surface of the flexible optoelectronic interconnection board on which the second electrical connection terminal is formed face to a same direction, and a portion of the flexible wiring board and at least a portion of the flexible optoelectronic interconnection board are stacked and fixed.

3. The module according to claim 2, wherein a through hole is formed in the flexible wiring board, and at least the optical semiconductor element mounted on the flexible optoelectronic interconnection board is placed in a region of the through hole.

4. The module according to claim 2, wherein the connecting member comprises one of a bonding wire and a conducting film.

5. The module according to claim 1, wherein a surface of the flexible wiring board on which the first electrical connection terminal is formed and a surface of the flexible optoelectronic interconnection board on which the second electrical connection terminal is formed are opposed to each other, and the first electrical connection terminal and the second electrical connection terminal are electrically connected with the connecting member being sandwiched therebetween.

6. The module according to claim 5, wherein a through hole is formed in the flexible wiring board, and at least the optical semiconductor element mounted on the flexible optoelectronic interconnection board is placed in a region of the through hole.

7. The module according to claim 5, wherein the connecting member comprises a bump or anisotropic conductive film (ACF) or anisotropic conductive paste (ACP).

8. The module according to claim 5, wherein the flexible optoelectronic interconnection board comprises a bent portion which positions the second electrical connection terminal close to the first electrical connection terminal.

9. The module according to claim 1, wherein the first electrical connection terminal is formed at each of two ends of the flexible wiring board, the second electrical connection terminal is formed at each of two ends of the flexible optoelectronic interconnection board, and the optical semiconductor element is formed at each of the two ends of the flexible optoelectronic interconnection board.

10. The module according to claim 1, wherein the flexible wiring board and the flexible optoelectronic interconnection board are fixed by a connecting member.

11. The module according to claim 9, wherein the optical semiconductor element comprises a light-emitting element and a light-receiving element at each of two ends of the flexible optoelectronic interconnection board.

12. The module according to claim 1, wherein a driving IC which drives the optical semiconductor element is mounted on the flexible optoelectronic interconnection board or flexible wiring board.

13. The module according to claim 1, wherein the conductive connecting member is covered with mold resin.

14. The module according to claim 1, wherein a stiffening plate having rigidity higher than those of the flexible wiring board and the flexible optoelectronic interconnection board is formed on a surface of the flexible wiring board, which is opposite to the surface on which the first electrical connection terminal is formed.

15. The module according to claim 14, wherein the stiffening plate is formed in a region except for the portion where the flexible optoelectronic interconnection board is mounted.

16. The module according to claim 14, wherein the stiffening plate has the thickness larger than that of the flexible optoelectronic interconnection board.

17. The module according to claim 1, wherein a through hole having a width larger than a width of an interconnection region of the flexible optoelectronic interconnection board is formed in a region of the flexible wiring board where the flexible optoelectronic interconnection board is mounted, except for an end region of the flexible optoelectronic interconnection board.

18. The module according to claim 1, wherein the flexible wiring board is divided into a plurality of thin lines by through holes parallel to a wiring direction in a wiring region where the electrical wire is formed, and the flexible optoelectronic interconnection board is mounted on one of the divided thin lines or thorough holes.

19. The module according to claim 18, wherein
the flexible wiring board has a crank shape, and
the plurality of thin lines are overlaid such that each of the thin lines comprises an upper surface facing a lower surface of another.

20. A method of manufacturing a flexible optoelectronic interconnection module according to claim 1, the first electrical connection terminal being formed at an end portion of the flexible wiring board, and a central portion being narrower than the end portion, the method comprising:
preparing a locking member including a through hole having a diameter smaller than the end portion of the flexible wiring board and larger than the central portion, and, before the first electrical connection terminal and the second electrical connection terminal are electrically connected, inserting the flexible wiring board and the flexible optoelectronic interconnection board into the through hole of the locking member, from one end of the flexible wiring board and one end of the flexible optoelectronic interconnection board; and
after the first electrical connection terminal of the flexible wiring board and the second electrical connection terminal of the flexible optoelectronic interconnection board are inserted into the through hole, electrically connecting the first electrical connection terminal and the second electrical connection terminal by the connecting member.
